(19) United States
(12) Patent Application Publication
(10) Pub. No.: US 2021/0316464 A1
(43) Pub. Date: Oct. 14, 2021

(54) Quick-Change Utility Knife

(71) Applicant: Eric Jay Alexander, Orem, UT (US)

(72) Inventor: Eric Jay Alexander, Orem, UT (US)

(21) Appl. No.: 16/845,780

(22) Filed: Apr. 10, 2020

(51) Int. Cl. B26B 5/00

(52) U.S. Cl. CPC B26B 5/001

(57) ABSTRACT

Quick-change utility knives can be rapidly opened, often without tools, such that the blade of the knives can be rapidly and readily changed. The knife can be achieved with a variety of body materials and sizes, and can be applied to both fixed and retractable knives equally. The knife separates into body portions that are secured together at the blade end by a physical structure. The opposite end of the body portions are secured together by a magnetic force. When the blade is to be changed, a separation force between the body portions overcomes the magnetic force, the body is opened, and the blade rapidly changed.

### BACKGROUND OF THE INVENTION

### 1. Field of the Invention

The present invention relates to utility knives, and more particularly to quick-change utility knives permitting rapid and tool-less changing of utility knife blades.

### 2. Background and Related Art

Utility knives or box cutters (collectively referred to herein as “utility knives”) are knives used for utility purposes. Utility knives are commonly used in workplaces as multi-purpose cutting tools for use in a variety of trades and crafts. Utility knives are generally designed to be lightweight and easy to use and carry. They are used for general cutting tasks, such as trimming plastic and wood, cutting tape, string, cardboard, and other packaging materials.

FIG. 1 shows an illustrative utility knife 10, illustrating common features of utility knives. The utility knife 10 includes a blade 12 that may be fixed or retractable. The blade 12 is commonly replaceable and inexpensive, thereby allowing the utility knife 10 to be an inexpensive tool. If the blade 12 is retractable, it is common for a button 14 or other actuator that can be safely actuated to be used to extend and/or retract the blade 12 from a body 16 of the knife 10. Some knives 10 have a spring-loaded mechanism that retracts the blade 12 automatically unless the button 14 is moved forward on the body, and other knives 10 lock the blade 12 in place at one of several positions unless the button 14 is actuated.

The body 14 for the typical utility knife 10 is shaped as an elongate handle that is comfortable for gripping by a human hand. Often, the body 14 is formed of two halves, a first half 18 and a second half 20. The first half 18 and the second half 20 are typically joined by a screw 22, and are often aligned by one or more physical features of the first half 18 and the second half 20 such that the blade 12 is secured and the user can safely use the knife 10 without cutting him or herself. Unfortunately, when it comes time to change the blade 12, the user must use a screwdriver to remove the screw 14, then must separate the first half 18 from the second half 20, replace or reverse the blade 12 before reassembling the knife 10.

The process of changing the blade is sufficiently time-consuming and obnoxious that users often do not replace the blade 12 as often as necessary. Instead, the user continues to use a dull blade 12, which may result in accidents or reduced cutting efficiency. Since blades 12 aren't changed in a timely fashion, manufacturers are also deprived of their revenue for selling the replacement blades 12. Sometimes, if a screwdriver is not available, replacing the blade 12 is simply impossible. While efforts have been made to provide systems to facilitate blade changing, they have been inadequate.

### BRIEF SUMMARY OF THE INVENTION

Implementation of the invention provides quick-change utility knives that address the deficiencies of existing utility knives. The quick-change utility knife can be rapidly opened, often without tools, such that the blade of the knife can be rapidly and readily changed. Implementation of the knife can be achieved with a variety of body materials and sizes, and can be applied to both fixed and retractable knives equally.

According to implementations of the invention, a quick-change utility knife includes a replaceable blade and a mounting member adapted to receive and engage the replaceable blade. The knife also includes a body adapted to receive and engage the mounting member and the replaceable blade in combination, the body having a generally elongate form shaped as a handle to be held by a human hand. The body includes a first body member extending along at least a portion of one major side of the replaceable blade and forming at least a first portion of the handle and a second body member extending along at least a portion of an opposite major side of the replaceable blade and forming at least a second portion of the handle. The body also includes a physical engagement mechanism proximate the replaceable blade adapted to secure the first body member to the second body member proximate the replaceable blade and a magnet disposed on a portion of the first body member distal the replaceable blade and directed toward a corresponding feature disposed on a portion of the second body member whereby the magnet serves to reversibly secure the first body member to the second body member distal the replaceable blade.

In some implementations, the corresponding feature includes a magnet. In some implementations, the magnets both include rare-earth magnets. In some implementations, the magnets both include neodymium magnets. In some implementations, the corresponding feature includes a ferromagnetic plate.

In some implementations, the first body member includes one or more indexing pins or indexing holes, and the second body member includes one or more indexing holes or indexing pins corresponding to the indexing pins or indexing holes of the first body member. The respective indexing pins and indexing holes are adapted to prevent movement of distal portions of the first body member relative to the second body member generally in a plane of the replaceable blade when the distal portion of the first body member is contacting the distal portion of the second body member. In some implementations, a distal portion of the first body member is formed in a first shape that corresponds to a second shape of a distal portion of the second body member. The first shape and the second shape engage to prevent movement of the distal portion of the first body member relative to the second body member generally in a plane of the replaceable blade when the distal portion of the first body member is contacting the distal portion of the second body member.

In some implementations, the quick-change utility knife further includes physical separation structures formed on each of the first body member and the second body member. The physical separation structures are adapted to permit application of a separating force between a distal end of the first body member and a distal end of the second body member generally perpendicular to a plane of the replaceable blade. In some implementations, the physical separation structures are adapted to receive the separating force from a flat item inserted between the physical separation structures. In some implementations, the physical separation structures are adapted to receive the separating force from one or more fingers of a human hand.

In some implementations, the replaceable blade is a fixed blade. In some implementations, the replaceable blade and the mounting member are slidable within the body whereby the replaceable blade is retractable within the body.

According to further implementations of the invention, a quick-change utility knife includes a replaceable blade and a mounting member adapted to receive and engage the replaceable blade. The knife also includes a body adapted to receive and engage the mounting member and the replaceable blade in combination, the body having a generally elongate form shaped as a handle to be held by a human hand. The body includes a first body member extending along at least a portion of one major side of the replaceable blade and forming at least a first portion of the handle and a second body member extending along at least a portion of an opposite major side of the replaceable blade and forming at least a second portion of the handle. The body also includes a physical engagement mechanism proximate the replaceable blade adapted to secure the first body member to the second body member proximate the replaceable blade, a first magnet disposed on an inner portion of the first body member distal the replaceable blade, and a second magnet disposed on an inner portion of the second body member at a location corresponding to the first magnet, whereby the first magnet and the second magnet serve to reversibly secure the first body member to the second body member distal the replaceable blade.

In some implementations, the magnets both include rare-earth magnets. In some implementations, the magnets both include neodymium magnets.

In some implementations, the first body member includes one or more indexing pins or indexing holes, and the second body member includes one or more indexing holes or indexing pins corresponding to the indexing pins or indexing holes of the first body member. The respective indexing pins and indexing holes are adapted to prevent movement of distal portions of the first body member relative to the second body member generally in a plane of the replaceable blade when the distal portion of the first body member is contacting the distal portion of the second body member. In some implementations, a distal portion of the first body member is formed in a first shape that corresponds to a second shape of a distal portion of the second body member. The first shape and the second shape engage to prevent movement of the distal portion of the first body member relative to the second body member generally in a plane of the replaceable blade when the distal portion of the first body member is contacting the distal portion of the second body member.

In some implementations, the quick-change utility knife further includes physical separation structures formed on each of the first body member and the second body member. The physical separation structures are adapted to permit application of a separating force between a distal end of the first body member and a distal end of the second body member generally perpendicular to a plane of the replaceable blade. In some implementations, the physical separation structures are adapted to receive the separating force from a flat item inserted between the physical separation structures. In some implementations, the physical separation structures are adapted to receive the separating force from one or more fingers of a human hand.

In some implementations, the replaceable blade is a fixed blade. In some implementations, the replaceable blade and the mounting member are slidable within the body whereby the replaceable blade is retractable within the body.

According to additional implementations of the invention, a quick-change utility knife includes a replaceable blade and a mounting member adapted to receive and engage the replaceable blade. The knife also includes a body adapted to receive and engage the mounting member and the replaceable blade in combination, the body having a generally elongate form shaped as a handle to be held by a human hand. The body includes a first body member extending along at least a portion of one major side of the replaceable blade and forming at least a first portion of the handle and a second body member extending along at least a portion of an opposite major side of the replaceable blade and forming at least a second portion of the handle. The body also includes a physical engagement mechanism proximate the replaceable blade adapted to secure the first body member to the second body member proximate the replaceable blade, a first rare-earth magnet disposed on an inner portion of the first body member distal the replaceable blade, and a second rare-earth magnet disposed on an inner portion of the second body member at a location corresponding to the first magnet, whereby the first magnet and the second magnet serve to reversibly secure the first body member to the second body member distal the replaceable blade.

In some implementations, the magnets both include neodymium magnets.

In some implementations, the first body member includes one or more indexing pins or indexing holes, and the second body member includes one or more indexing holes or indexing pins corresponding to the indexing pins or indexing holes of the first body member. The respective indexing pins and indexing holes are adapted to prevent movement of distal portions of the first body member relative to the second body member generally in a plane of the replaceable blade when the distal portion of the first body member is contacting the distal portion of the second body member. In some implementations, a distal portion of the first body member is formed in a first shape that corresponds to a second shape of a distal portion of the second body member. The first shape and the second shape engage to prevent movement of the distal portion of the first body member relative to the second body member generally in a plane of the replaceable blade when the distal portion of the first body member is contacting the distal portion of the second body member.

In some implementations, the quick-change utility knife further includes physical separation structures formed on each of the first body member and the second body member. The physical separation structures are adapted to permit application of a separating force between a distal end of the first body member and a distal end of the second body member generally perpendicular to a plane of the replaceable blade. In some implementations, the physical separation structures are adapted to receive the separating force from a flat item inserted between the physical separation structures. In some implementations, the physical separation structures are adapted to receive the separating force from one or more fingers of a human hand.

In some implementations, the replaceable blade is a fixed blade. In some implementations, the replaceable blade and the mounting member are slidable within the body whereby the replaceable blade is retractable within the body.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a side view of a prior-art utility knife;

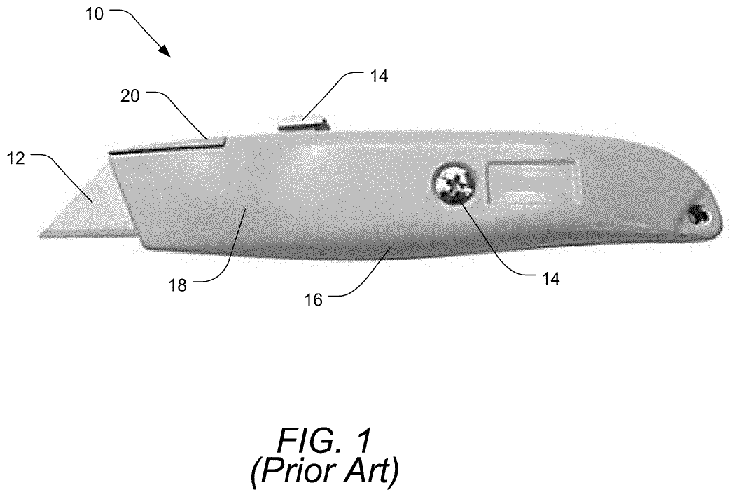

FIG. 2 shows an exploded plan view of an exemplary embodiment of a quick-change utility knife;

FIG. 3 shows a side view of an exemplary embodiment of a quick-change utility knife;

FIG. 4 shows a side view of another exemplary embodiment of a quick-change utility knife; and

FIG. 5 shows a side view of another exemplary embodiment of a quick-change utility knife.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

According to embodiments of the invention, a quick-change utility knife includes a replaceable blade and a mounting member adapted to receive and engage the replaceable blade. The knife also includes a body adapted to receive and engage the mounting member and the replaceable blade in combination, the body having a generally elongate form shaped as a handle to be held by a human hand. The body includes a first body member extending along at least a portion of one major side of the replaceable blade and forming at least a first portion of the handle and a second body member extending along at least a portion of an opposite major side of the replaceable blade and forming at least a second portion of the handle. The body also includes a physical engagement mechanism proximate the replaceable blade adapted to secure the first body member to the second body member proximate the replaceable blade and a magnet disposed on a portion of the first body member distal the replaceable blade and directed toward a corresponding feature disposed on a portion of the second body member whereby the magnet serves to reversibly secure the first body member to the second body member distal the replaceable blade.

In some embodiments, the corresponding feature includes a magnet. In some embodiments, the magnets both include rare-earth magnets. In some embodiments, the magnets both include neodymium magnets. In some embodiments, the corresponding feature includes a ferromagnetic plate.

In some embodiments, the first body member includes one or more indexing pins or indexing holes, and the second body member includes one or more indexing holes or indexing pins corresponding to the indexing pins or indexing holes of the first body member. The respective indexing pins and indexing holes are adapted to prevent movement of distal portions of the first body member relative to the second body member generally in a plane of the replaceable blade when the distal portion of the first body member is contacting the distal portion of the second body member. In some embodiments, a distal portion of the first body member is formed in a first shape that corresponds to a second shape of a distal portion of the second body member. The first shape and the second shape engage to prevent movement of the distal portion of the first body member relative to the second body member generally in a plane of the replaceable blade when the distal portion of the first body member is contacting the distal portion of the second body member.

In some embodiments, the quick-change utility knife further includes physical separation structures formed on each of the first body member and the second body member. The physical separation structures are adapted to permit application of a separating force between a distal end of the first body member and a distal end of the second body member generally perpendicular to a plane of the replaceable blade. In some embodiments, the physical separation structures are adapted to receive the separating force from a flat item inserted between the physical separation structures. In some embodiments, the physical separation structures are adapted to receive the separating force from one or more fingers of a human hand.

In some embodiments, the replaceable blade is a fixed blade. In some embodiments, the replaceable blade and the mounting member are slidable within the body whereby the replaceable blade is retractable within the body.

According to further embodiments of the invention, a quick-change utility knife includes a replaceable blade and a mounting member adapted to receive and engage the replaceable blade. The knife also includes a body adapted to receive and engage the mounting member and the replaceable blade in combination, the body having a generally elongate form shaped as a handle to be held by a human hand. The body includes a first body member extending along at least a portion of one major side of the replaceable blade and forming at least a first portion of the handle and a second body member extending along at least a portion of an opposite major side of the replaceable blade and forming at least a second portion of the handle. The body also includes a physical engagement mechanism proximate the replaceable blade adapted to secure the first body member to the second body member proximate the replaceable blade, a first magnet disposed on an inner portion of the first body member distal the replaceable blade, and a second magnet disposed on an inner portion of the second body member at a location corresponding to the first magnet, whereby the first magnet and the second magnet serve to reversibly secure the first body member to the second body member distal the replaceable blade.

In some embodiments, the magnets both include rare-earth magnets. In some embodiments, the magnets both include neodymium magnets.

In some embodiments, the first body member includes one or more indexing pins or indexing holes, and the second body member includes one or more indexing holes or indexing pins corresponding to the indexing pins or indexing holes of the first body member. The respective indexing pins and indexing holes are adapted to prevent movement of distal portions of the first body member relative to the second body member generally in a plane of the replaceable blade when the distal portion of the first body member is contacting the distal portion of the second body member. In some embodiments, a distal portion of the first body member is formed in a first shape that corresponds to a second shape of a distal portion of the second body member. The first shape and the second shape engage to prevent movement of the distal portion of the first body member relative to the second body member generally in a plane of the replaceable blade when the distal portion of the first body member is contacting the distal portion of the second body member.

In some embodiments, the quick-change utility knife further includes physical separation structures formed on each of the first body member and the second body member. The physical separation structures are adapted to permit application of a separating force between a distal end of the first body member and a distal end of the second body member generally perpendicular to a plane of the replaceable blade. In some embodiments, the physical separation structures are adapted to receive the separating force from a flat item inserted between the physical separation structures. In some embodiments, the physical separation structures are adapted to receive the separating force from one or more fingers of a human hand.

In some embodiments, the replaceable blade is a fixed blade. In some embodiments, the replaceable blade and the mounting member are slidable within the body whereby the replaceable blade is retractable within the body.

According to additional embodiments of the invention, a quick-change utility knife includes a replaceable blade and a mounting member adapted to receive and engage the replaceable blade. The knife also includes a body adapted to receive and engage the mounting member and the replaceable blade in combination, the body having a generally elongate form shaped as a handle to be held by a human hand. The body includes a first body member extending along at least a portion of one major side of the replaceable blade and forming at least a first portion of the handle and a second body member extending along at least a portion of an opposite major side of the replaceable blade and forming at least a second portion of the handle. The body also includes a physical engagement mechanism proximate the replaceable blade adapted to secure the first body member to the second body member proximate the replaceable blade, a first rare-earth magnet disposed on an inner portion of the first body member distal the replaceable blade, and a second rare-earth magnet disposed on an inner portion of the second body member at a location corresponding to the first magnet, whereby the first magnet and the second magnet serve to reversibly secure the first body member to the second body member distal the replaceable blade.

In some embodiments, the magnets both include neodymium magnets.

In some embodiments, the first body member includes one or more indexing pins or indexing holes, and the second body member includes one or more indexing holes or indexing pins corresponding to the indexing pins or indexing holes of the first body member. The respective indexing pins and indexing holes are adapted to prevent movement of distal portions of the first body member relative to the second body member generally in a plane of the replaceable blade when the distal portion of the first body member is contacting the distal portion of the second body member. In some embodiments, a distal portion of the first body member is formed in a first shape that corresponds to a second shape of a distal portion of the second body member. The first shape and the second shape engage to prevent movement of the distal portion of the first body member relative to the second body member generally in a plane of the replaceable blade when the distal portion of the first body member is contacting the distal portion of the second body member.

In some embodiments, the quick-change utility knife further includes physical separation structures formed on each of the first body member and the second body member. The physical separation structures are adapted to permit application of a separating force between a distal end of the first body member and a distal end of the second body member generally perpendicular to a plane of the replaceable blade. In some embodiments, the physical separation structures are adapted to receive the separating force from a flat item inserted between the physical separation structures. In some embodiments, the physical separation structures are adapted to receive the separating force from one or more fingers of a human hand.

In some embodiments, the replaceable blade is a fixed blade. In some embodiments, the replaceable blade and the mounting member are slidable within the body whereby the replaceable blade is retractable within the body.

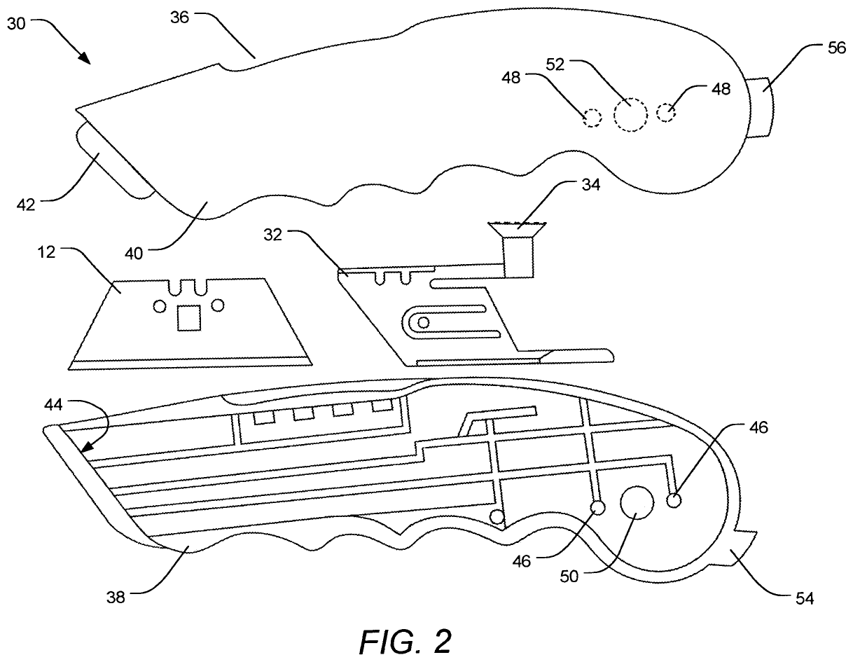

FIG. 2 illustrates an exploded view of one embodiment of a utility knife 30 in accordance with embodiments of the invention. The knife 30 includes the blade 12 which is illustrated as a conventional utility knife blade, but it should be understood that the blade 12 may be provided in any desired conventional or special shape, and the illustrated blade 12 is not intended to be limiting on the types of blade 12 that may be used with embodiments of the invention. The blade 12 is secured within the knife 30 on a carriage 32, which is one example of a mounting member adapted to engage and receive the blade 12. The knife 30 illustrated in FIG. 2 is an example of a retractable utility knife, and accordingly the carriage 32 is adapted to move within a body of the knife 30 as actuated by a button 34 that moves within a slot 36 formed in the body and adapted to receive the button 34 of the carriage 32. In alternate embodiments of the knife 30, the blade 12 is fixed and the mounting member is formed as a fixed portion of the body of the knife 30.

The body of the knife 30 is adapted to receive the carriage 32 and the blade 12 in a channel or hollow therein. Additionally, in some embodiments of the invention, additional replacement blades 12 are storable in a separate portion of the body of the knife 30, such as a secondary storage hollow or channel. The body of the knife 30 is formed of two members, a first body member 38 and a second body member 40. In some embodiments, the first body member 38 and the second body member 40 each form roughly half of the body, as illustrated in FIG. 2, but such is not required of all embodiments of the knife 30. In some embodiments of the knife 30, the body is formed with ergonomic grips such as finger grips (as illustrated in FIG. 2), but such is not required of all embodiments of the knife 30.

The first body member 38 and the second body member 40 each include a physical engagement mechanism or structure proximate the blade end of the knife 30 that is adapted to reversibly secure the first body member 38 to the second body member 40 generally proximate the blade 12. Such physical engagement mechanisms or structures are commonly used in utility knives, and knives 30 in accordance with embodiments of the invention may incorporate any such engagement structure or mechanism. The mechanism illustrated in FIG. 2 includes a tab 42 formed on the blade end of the second body member 40, and a corresponding slot 44 formed in the first body member 38. The slot 44 serves both to provide a passage for the blade 12 to extend from the knife 30 as well as to receive the tab 42. When the knife 30 is assembled, the blade 12 is placed on the carriage 32 in or on the first body member 38, and the second body member 40 is brought close to the first body member 38 with the blade end of the second body member 40 somewhat closer to the first body member 38 such that the slot tab 42 can enter the slot 44.

Next, the other end (the end distal from or away from the blade 12) of the second body member 40 is generally aligned with and then brought toward the other end of the first body member 38 until the first body member 38 and the second body member 40 come fully together such that the knife 30 is fully assembled. The alignment of the first body member 38 and the second body member 40 of this embodiment is assisted by one or more indexing pins 46 formed on the inner surface of the first body member 38 and one or more corresponding indexing holes 48 formed on the inner surface of the second body member 40. While FIG. 2 shows two indexing pins 46 on the first body member 38 and two indexing holes 48 on the second body member 40, other embodiments utilize more or fewer indexing pins 46 and indexing holes 48 and/or reverse placement of one or more of the indexing pins 46 and indexing holes 48 (e.g., placing an indexing pin 46 on the second body member 40 and a corresponding indexing hole 48 on the first body member 38). Where one or more indexing pins 46 and indexing holes 48 are present, they are placed so as not to interfere with extra blade storage and generally away from the blade end of the knife 30.

The indexing pins 46 and the corresponding indexing holes 48 are one example of a structure adapted to minimize or prevent motion of the first body member 38 relative to the second body member 40 generally in a plane of the blade 12. The indexing pins 46 and the indexing holes 48 minimize or prevent such motion at a portion of the knife 30 away from the blade 12, and the engagement of the tab 42 and the slot 44 serve to minimize or prevent such motion proximate the blade 12.

A separate mechanism of the knife 30 serves to minimize unwanted separation motion of the first body member 38 from the second body member 40 at a location away from the blade 12. This mechanism for securing the first body member 38 to the second body member 40 includes a first magnet 50 located on an inner surface of the first body member 38 and a corresponding second magnet 52 located on an inner surface of the second body member 40. In some embodiments, either the first magnet 50 or the second magnet 52 is replaced by a corresponding ferromagnetic plate; however, the remaining magnet 50, 52 and the ferromagnetic plate are sized, placed, and selected so as to provide a sufficiently secure attachment between the first body member 38 and the second body member 40.

The first magnet 50 and the second magnet 52 in some embodiments are both rare earth magnets. In some embodiments, the first magnet 50 and the second magnet 52 are both neodymium magnets. The first magnet 50 and the second magnet 52 may have any desired size, shape, and thickness so as to permit the first magnet 50 and the second magnet 52 to achieve a desired engagement strength when the first body member 38 and the second body member 40 are closed to complete the knife 30. By way of example, the first magnet 50 and the second magnet 52 may be cylindrical shaped, hemi-spherical shaped, or may be rectangular prism shaped. The first magnet 50 and the second magnet 52 may be affixed or secured to the first body member 38 and the second body member 40, respectively, using any desired method, including gluing, bonding, press-fit, or the like.

As illustrated in FIG. 2, the first magnet 50 and the second magnet 52 are located generally toward the opposite end of the knife 30 from the blade end. As the physical engagement between the first body member 38 and the second body member 40 (e.g., the slot 44 and tab 42 of the embodiment of FIG. 2) keeps the blade end of the knife 30 together, the first magnet 50 and the second magnet 52 keep the butt end of the knife 30 together during normal use when separation is not desired. The engagement force between the first magnet 50 and the second magnet 52 (or between any combination of any desirable number of magnets and ferromagnetic plates) is sufficient to keep the first body member 38 and the second body member 40 together in most circumstances.

When the knife 30 is to be closed, as discussed above, the tab 42 is engaged with the slot 44 (or some other blade-end physical engagement mechanism between the first body member 38 and the second body member 40 is engaged) while some separation is maintained between the butt ends of the first body member 38 and the second body member 40. Once the tab 42 is engaged with the slot 44, the indexing pins 46 are aligned with the indexing holes 48, and these features are initially engaged with each other. As this engagement occurs, the first magnet 50 and the second magnet 52 experience a mutual magnetic attraction, and the butt ends of the first body member 38 and the second body member 40 snap together. The first magnet 50 and the second magnet 52 hold the knife 30 together during normal use and against unwanted separation.

When the time comes to change the blade 12, the user wishes to separate the first body member 38 from the second body member 40 at will. Accordingly, the embodiment of the knife 30 shown in FIG. 2 provides physical structures located on the first body member 38 and the second body member 40 that permit the application of a separation force between the first body member 38 and the second body member generally perpendicular to the plane of the blade 12. These physical structures are provided as a first tab 54 on the first body member 38 and a second tab 56 on the second body member 40. The separation force may be applied by fingers of the user or by a twisting force supplied by a flat object such as a coin or flat-blade screwdriver.

In some embodiments, the physical structure for applying the separation force may be provided by alternate shapes than those illustrated in FIG. 2. By way of example, the physical structure in some embodiments may be provided by a slot disposed at the joinder of the first body member 38 and the second body member 40 adapted to receive a flat object and receive a twisting force therefrom. In other embodiments, the physical structure may be provided by a single tab on one of the first body member 38 or the second body member 40, and a grip portion provided on the other of the first body member 38 or the second body member 40. Accordingly, the physical structure providing for application of a separation force between the first body member 38 and the second body member 40 is not limited to the physical structure shown in FIG. 2.

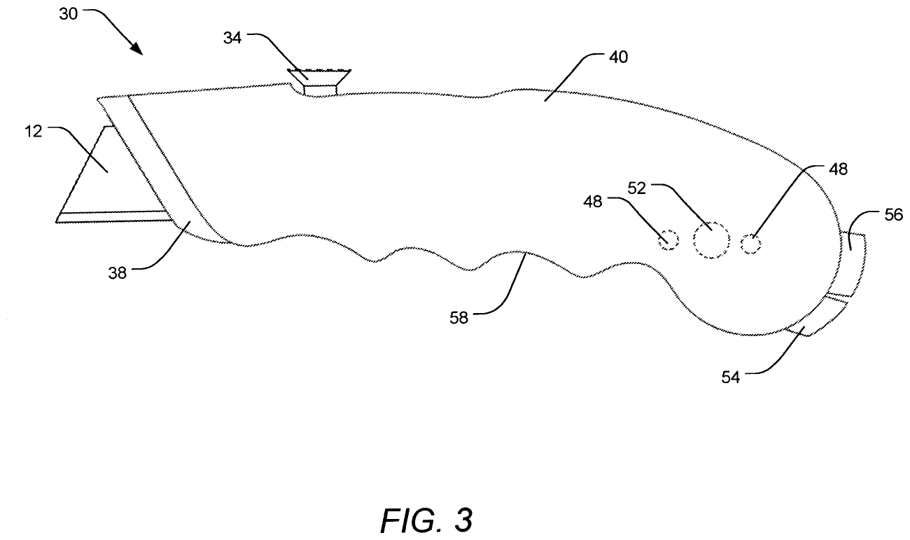

FIG. 3 shows a side view of the assembled knife 30, showing how when the tab 42 is engaged with the slot 44 and the first magnet 50 is engaged with the second magnet 52, the knife 30 is formed as a unitary construct that provides for use as with any traditional utility knife. As discussed previously, in this embodiment, the body of the knife 30 is formed with an ergonomic grip 58 formed to receive fingers of a user thereon. As may also be seen in FIG. 3, the first tab 54 and the second tab 56 are formed side-by-side in this embodiment to permit at-will separation of the first body member 38 from the second body member 40 at any time.

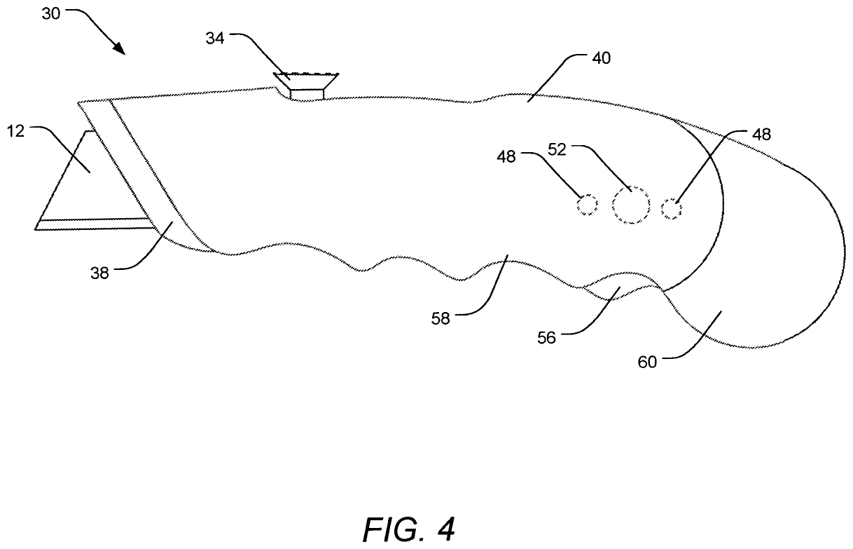

FIG. 4 shows a side view of an alternate embodiment of the assembled knife 30. This embodiment shares many of the features of the embodiment of FIGS. 2-3, including the retractable blade 12 operated by the button 34. Still other alternate embodiments remove the button 34 (and the slot 36) in favor of a fixed version of the blade 12, as may be appreciated by those skilled in the art. In this embodiment, the first magnet 50 and the second magnet 52 are located more toward the blade end of the knife 30, as are the indexing pins 46 and the indexing holes 48.

As may also be noted from FIG. 4, the first body member 38 of this embodiment is significantly longer than the second body member 40. In this embodiment, the first body member 38 forms both halves of the butt end of the knife 30, forming a curved receiving shape that receives a correspondingly curved butt end of the second body member 40. In this embodiment, the receiving shape 60 of the first body member 38 serves as one part of the physical structure to separate the first body member 38 from the second body member 40. Thus, there is only the second tab 56 (now located toward the bottom of the second body member 40) necessary to provide a separation force between the first body member 38 and the second body member 40.

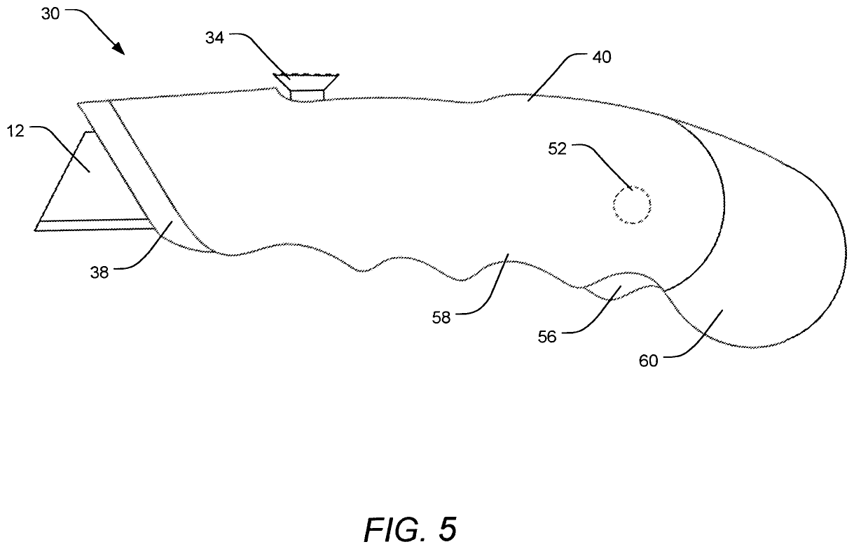

FIG. 5 illustrates another embodiment of the knife 30. In this embodiment, the engagement pins 46 and the engagement holes 48 are omitted, as the receiving shape 60 of the butt end of the first body member 38 and the corresponding shape of the second body member 40 serve to align the members 38, 40 as the body is closed. In some embodiments, the receiving shape 60 of the first body member 38 serves as the first physical structure to permit separation of the first body member 38 from the second body member 38, and a corresponding portion of the second body member 40 that forms both halves of the body serves as the second physical structure to permit separation. Accordingly, the knife 30 may take many shapes and forms.

The first body member 38 and the second body member 40 may be formed of any desired material. In some embodiments, one or both members 38, 40, are largely formed of impact-resistant plastic. In other embodiments, one or both members 38, 40 are largely formed of non-ferromagnetic metal, such as aluminum or stainless steel. In other embodiments, at least parts of one or both members 38, 40, are formed at least in part of ferromagnetic materials such as iron or steel alloys. In some embodiments, the knife 30 includes an external clip or magnet that allows the knife 30 to be secured to other objects, such as a tool chest, tool belt, or pocket.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A quick-change utility knife comprising:
a replaceable blade;
a mounting member adapted to receive and engage the replaceable blade;
a body adapted to receive and engage the mounting member and the replaceable blade in combination, the body having a generally elongate form shaped as a handle to be held by a human hand and comprising:
a first body member extending along at least a portion of one major side of the replaceable blade and forming at least a first portion of the handle;
a second body member extending along at least a portion of an opposite major side of the replaceable blade and forming at least a second portion of the handle;
a physical engagement mechanism proximate the replaceable blade adapted to secure the first body member to the second body member proximate the replaceable blade; and
a magnet disposed on a portion of the first body member distal the replaceable blade and directed toward a corresponding feature disposed on a portion of the second body member whereby the magnet serves to reversibly secure the first body member to the second body member distal the replaceable blade.

2. The quick-change utility knife as recited in claim 1, wherein the corresponding feature comprises a magnet.

3. The quick-change utility knife as recited in claim 2, wherein the magnets both comprise rare-earth magnets.

4. The quick-change utility knife as recited in claim 2, wherein the magnets both comprise neodymium magnets.

5. The quick-change utility knife as recited in claim 1, wherein the corresponding feature comprises a ferromagnetic plate.

6. The quick-change utility knife as recited in claim 1, wherein the first body member comprises one or more indexing pins or indexing holes, and wherein the second body member comprises one or more indexing holes or indexing pins corresponding to the indexing pins or indexing holes of the first body member, whereby the respective indexing pins and indexing holes are adapted to prevent movement of distal portions of the first body member relative to the second body member generally in a plane of the replaceable blade when the distal portion of the first body member is contacting the distal portion of the second body member.

7. The quick-change utility knife as recited in claim 1, wherein a distal portion of the first body member is formed in a first shape that corresponds to a second shape of a distal portion of the second body member, such that the first shape and the second shape engage to prevent movement of the distal portion of the first body member relative to the second body member generally in a plane of the replaceable blade when the distal portion of the first body member is contacting the distal portion of the second body member.

8. The quick-change utility knife as recited in claim 1, further comprising physical separation structures formed on each of the first body member and the second body member, the physical separation structures being adapted to permit application of a separating force between a distal end of the first body member and a distal end of the second body member generally perpendicular to a plane of the replaceable blade.

9. The quick-change utility knife as recited in claim 8, wherein the physical separation structures are adapted to receive the separating force from a flat item inserted between the physical separation structures.

10. The quick-change utility knife as recited in claim 8, wherein the physical separation structures are adapted to receive the separating force from one or more fingers of a human hand.

11. The quick-change utility knife as recited in claim 1, wherein the replaceable blade is a fixed blade.

12. The quick-change utility knife as recited in claim 1, wherein the replaceable blade and the mounting member are slidable within the body whereby the replaceable blade is retractable within the body.

13. A quick-change utility knife comprising:
a replaceable blade;
a mounting member adapted to receive and engage the replaceable blade;
a body adapted to receive and engage the mounting member and the replaceable blade in combination, the body having a generally elongate form shaped as a handle to be held by a human hand and comprising:
a first body member extending along at least a portion of one major side of the replaceable blade and forming at least a first portion of the handle;
a second body member extending along at least a portion of an opposite major side of the replaceable blade and forming at least a second portion of the handle;
a physical engagement mechanism proximate the replaceable blade adapted to secure the first body member to the second body member proximate the replaceable blade;
a first magnet disposed on an inner portion of the first body member distal the replaceable blade; and
a second magnet disposed on an inner portion of the second body member at a location corresponding to the first magnet, whereby the first magnet and the second magnet serve to reversibly secure the first body member to the second body member distal the replaceable blade.

14. The quick-change utility knife as recited in claim 13, wherein the magnets both comprise rare-earth magnets.

15. The quick-change utility knife as recited in claim 13, wherein the first body member comprises one or more indexing pins or indexing holes, and wherein the second body member comprises one or more indexing holes or indexing pins corresponding to the indexing pins or indexing holes of the first body member, whereby the respective indexing pins and indexing holes are adapted to prevent movement of distal portions of the first body member relative to the second body member generally in a plane of the replaceable blade when the distal portion of the first body member is contacting the distal portion of the second body member.

16. The quick-change utility knife as recited in claim 13, wherein a distal portion of the first body member is formed in a first shape that corresponds to a second shape of a distal portion of the second body member, such that the first shape and the second shape engage to prevent movement of the distal portion of the first body member relative to the second body member generally in a plane of the replaceable blade when the distal portion of the first body member is contacting the distal portion of the second body member.

17. The quick-change utility knife as recited in claim 13, further comprising physical separation structures formed on each of the first body member and the second body member, the physical separation structures being adapted to permit application of a separating force between a distal end of the first body member and a distal end of the second body member generally perpendicular to a plane of the replaceable blade.

18. The quick-change utility knife as recited in claim 13, wherein the replaceable blade is a blade selected from the group consisting of a fixed blade and a retractable blade.

19. A quick-change utility knife comprising:
a replaceable blade;
a mounting member adapted to receive and engage the replaceable blade;
a body adapted to receive and engage the mounting member and the replaceable blade in combination, the body having a generally elongate form shaped as a handle to be held by a human hand and comprising:
a first body member extending along at least a portion of one major side of the replaceable blade and forming at least a first portion of the handle;
a second body member extending along at least a portion of an opposite major side of the replaceable blade and forming at least a second portion of the handle;
a physical engagement mechanism proximate the replaceable blade adapted to secure the first body member to the second body member proximate the replaceable blade;
a first rare-earth magnet disposed on an inner portion of the first body member distal the replaceable blade; and
a second rare-earth magnet disposed on an inner portion of the second body member at a location corresponding to the first magnet, whereby the first magnet and the second magnet serve to reversibly secure the first body member to the second body member distal the replaceable blade.

20. The quick-change utility knife as recited in claim 19, further comprising physical separation structures formed on each of the first body member and the second body member, the physical separation structures being adapted to permit application of a separating force between a distal end of the first body member and a distal end of the second body member generally perpendicular to a plane of the replaceable blade.
